(19) United States
(12) Patent Application Publication
(10) Pub. No.: US 2003/0055891 A1
(43) Pub. Date: Mar. 20, 2003

(54) Client device, process server, and network system

(75) Inventor: Yoshifumi Tanimoto, Hirakata shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/227,975

(22) Filed: Aug. 26, 2002

(30) Foreign Application Priority Data
Aug. 27, 2001 (JP) 2001-255567

(51) Int. Cl. G06F 15/16

(52) U.S. Cl. 709/203

(57) ABSTRACT

A client device includes a communication device for communicating with a process server or a management server through a Local Area Network (LAN). A control unit operates in a first mode transferring information to and from the process server through the management server by making the communication device communicate with the management server and operates in a second mode transferring information directly to and from the process server by making the communication device communicate with the process server.

### BACKGROUND OF THE INVENTION

1. Field of the Invention

The present invention relates to a network system where one or a plurality of process servers, one or a plurality of management servers for managing the process servers, and one or a plurality of client devices are connected to a LAN.

2. Description of the Related Art

Various devices such as facsimile devices, printers, and scanners can be connected to the LAN as process servers, and are controlled by the client devices also connected to the LAN. These process servers normally receive login requests from each client device, process information transmitted from each client device, and deliver the processed information to each client device. In the case that a plurality of the process servers are connected to the LAN, information must be transferred with users being conscious of which process server the information is transferred to or from in the client devices.

Meanwhile, a system, where a management server which manages a plurality of the process servers is connected to the LAN and all the process servers are managed by the management server, is also used. In this system, there is an advantage that the user of the client device can transfer information to or from the management server without being conscious that which process server information is transferred to or from. There is also an advantage that the management can be easier as the management server manages all the process servers when managing the system.

So far, either system in the above description can only be adopted and the system configuration cannot be flexible. More specifically, in the system configuration that information is transferred directly to or from each client device, the process server receives login request from a plurality of the client devices and communicates with each client device. In the case the management server manages the process server as described above, the process server also recognizes the management server as one client device, receives login request, and transfers information. In this case, the process server can receive login request of the other client device without the management server, and it becomes pointless to manage with the management server. Moreover in the system configuration that the information is transferred only between the process server and the management server, the management server becomes essential, or communicates only with one client device, so that there is a problem that they cannot be used respectively from a plurality of the client devices.

Moreover, there is a problem that the system configuration such as combining the above systems cannot be adopted such that the management server manages the process server and the information to be processed or the processed information is transferred directly between the process server and the client device.

The present invention is provided in view of the above problems, and it is an advantage of the present invention to provide the process server and the client device which are responsive to both the system wherein information is transferred directly between the client device and the process server and the system of installing the management server which manages the process server.

### SUMMARY OF THE INVENTION

A client device of the present invention in a network system where one or a plurality of process servers, one or a plurality of management servers for managing the process server, and one or a plurality of client devices are connected to a LAN (Local Area Network) includes a communication means for communicating with the process server or the management server through the LAN, a first mode that information is transferred to or from the process server through the management server by making the communication means communicate with the management server, and a second mode that information is transferred directly to or from the process server through the management server by making the communication means communicate with the process server.

Moreover, the client device of the present invention transfers device setup information for the process server in the first mode, and transfers the information to be processed in the process server in the second mode.

Furthermore, the client device of the present invention transfers information to be processed in the process server in the first mode, and transfers the device setup information for the process server in the second mode.

A process server of the present invention in a network system where one or a plurality of process servers, one or a plurality of management servers for managing the process server, and one or a plurality of client devices are connected to the LAN (Local Area Network) includes a communication means for communicating with the management server or the client device through the LAN, a process means for processing information, a first mode that information transmitted from the client device is transferred to the process means through the management server or information processed by the process means is transmitted to the client device through the management server by making the communication means communicate with the management server, and a second mode that information received directly from the client device is transferred to the process means or information processed by the process means is transmitted directly to the client device by making the communication means communicate with the client device.

Moreover, the process server of the present invention transfers the device setup information in the first mode, and transfers information to be processed by the process means in its device or the processed information in the second mode.

Furthermore, the process server of the present invention transfers the information to be processed by the process means in its device or the processed information in the first mode, and transfers the device setup information regarding its device in the second mode.

In a network system of the present invention where one or a plurality of process servers, one or a plurality of management servers for managing the process server, and one or a plurality of client devices are connected to the LAN (Local Area Network), the client device includes a communication means for communicating with the process server or the management server through the LAN, the first mode that information is transferred to or from the process server through the management server by making the communication means communicate with the management server and the second mode that information is transferred directly to or from the process server by making the communication means communicate with the process server. The process server includes the communication means for communicating with the management server and the client device, the process means for processing information, the first mode that information transmitted from the client device is transferred to the process means through the management server or information processed by the process means is transmitted to the client device through the management server by making the management server communicate with the communication means, and the second mode that information received directly from the client device is transferred to the process means or the information processed by the process means is transmitted directly to the client device by making the communication means communicate with the client device.

Also, in the network system of the present invention, the client device communicates with the process server in the first mode when transferring the device setup information, and communicates in the second mode when transferring information to be processed in the process server.

Moreover, in the network system of the present invention, the client device communicates in the first mode when transferring the information to be processed in the process server, and communicates with the process server in the second mode when transferring the device setup information.

Furthermore in the network system of the present invention, the process server communicates in the first mode when transferring the device setup information regarding its device, and communicates in the second communication mode when transferring the information to be processed by the process means in its device or the processed information.

Besides, in the network system of the present invention, the process server communicates in the first mode when transferring information to be processed by the process means in its device or the processed information, and communicates in the second mode when transferring the device setup information regarding the own device.

According to the present invention, the client device and the process server include the first mode that information is transferred between the process server and the client device through the management server and the second mode that information is transferred directly, there is an effect that the system can be constructed without limiting by the presence of the management server and the usage.

Moreover, the system can be constructed such that the first mode or the second mode can be applied in transferring the device setup information to and from the process server and transferring the information to be processed in the process server respectively, so that the system can be constructed more flexibly.

### BRIEF DESCRIPTION OF THE DRAWINGS

FIG. 1 is a block diagram showing one example of a network system including a client device and a process server of the present invention.

FIG. 2 is an explanation drawing of one example of an operation in case of carrying out a network print in the network system including the client device and the process server of the present invention.

FIG. 3 is an explanation drawing of one example of an operation in case of using a first mode and a second mode together in one example of the network system including the client device and the process server of the present invention.

FIG. 4 is an explanation drawing of one example of an operation in case of delivering receipt information in the network system including the client device and the process server of the present invention.

### DETAILED DESCRIPTION OF THE PREFERRED EMBODIMENT

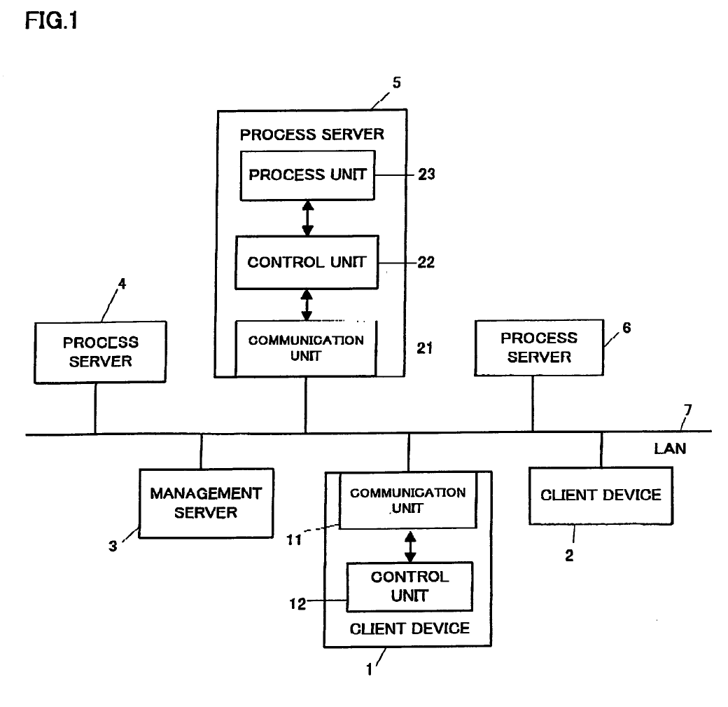

In FIG. 1, reference numbers 1 and 2 show client devices, 3 shows a management server, 4˜6 show process servers, 7 shows a LAN, 11 shows a communication unit, 12 shows a control unit, 21 shows a communication unit, 22 shows a control unit, and 23 shows a process unit. FIG. 1 shows an example of the network system that two client devices 1 and 2, one management server 3, and three process servers 4˜6 are connected to the LAN 7. The number of the above devices is optional, and other various kinds of network devices can be connected to the LAN 7.

The client devices 1 and 2 can transfer information to the process servers 4˜6 through the LAN 7, make a request to the process servers 4˜6 for processing the information, and receive the information processed in the process servers 4˜6. At the time, the way of transferring information to and from the process servers 4˜6, whether through the management server 3 or directly, can be changed by the device setup information. Moreover, sometimes the client device 1 or the client device 2 can transfer the device setup information to one or all of the process servers 4˜6 to set the device. In the case, the way of transferring the device setup information, whether through the management server 3 or directly, can be changed by the setup. The setup can be made independently from a setup in transferring information for requesting a process or the processed information.

The client device 1 has the communication unit 11 and the control unit 12. Additionally, the client device 2 also has the same configuration as the client device 1, which is not shown in FIG. 1. The communication unit 11 communicates with the process servers 4˜6 and the management server 3 through the LAN 7. Moreover, the control unit 12 carries out various controls and processes in the client device 1. In particular, the control unit 12 controls the communication unit 11 so as to communicate in a first mode that information is transferred to and from the process servers 4˜6 through the management server 3 by making the communication unit 11 communicate with the management server 3 or a second mode that information is transferred directly to and from the process server by making the communication unit 11 communicate with the process servers 4˜6, when requesting the process servers 4˜6 to process the information or receiving information processed in the process servers 4˜6. Furthermore, the control unit 12 controls the communication unit 11 so as to communicate with the process server 4˜6 in the first mode or the second mode when transferring the device setup information.

The management server 3 can manage the process servers 4˜6 and manage a job to the process servers 4˜6. In case of the job management, the process can be requested to any one of the process servers 4˜6, based on the request received from the client devices 1 and 2, or the process can be made by dividing the request into several parts. Moreover, the management server 3 receives a process result in the process servers 4˜6 and delivers it to the client devices 1 and 2. In addition, when the client devices 1 and 2 communicate with the process servers 4˜6 directly (in the second mode), the system can be constructed without providing the management server 3.

The process server 4˜6 carry out various processes based on the request received from the client devices 1 and 2. For example, the process servers 4˜6 carry out a print process for receiving information and printing it out and a scan process that information on a document is scanned and delivered. Or, it can provide a transmission process of receiving information and transmitting facsimile, and a receipt process of delivering information received by the facsimile. In addition to this, the process servers 4˜6 can carry out various processes by receiving information and reply the process result, or carry out various processes such as generating information and delivering.

The process server 5 has the communication unit 21, the control unit 22, and the process unit 23. Additionally, the process servers 4 and 6 basically have the same configuration as the process server 5 except for a process content carried out in the process unit 23, which is not shown in FIG. 1. The communication unit 21 communicates with the client servers 1, 2 and the management server 3 through the LAN 7.

The control unit 22 implements various controls and processes in the process server 5. In particular, the control unit 22 controls so as to communicate in the first mode that information is transferred through the management server 3 by making the communication unit 21 communicate with the management server 3 or in the second mode that information is transferred directly to or from the client devices 1, 2 by making the communication unit 21 communicate with the client devices 1, 2, when information to be processed is received from the client devices 1, 2 or the process result is transferred to the client devices 1, 2. Additionally, if a plurality of processes can be made in the process unit 23, it can be constructed such that the first mode or the second mode can be set respectively in every process classification. Furthermore, the control unit 22 controls so as to communicate in the first mode or the second mode to transfer the device setup information regarding the own device.

In case of using the first mode as described above, the management server 3 is registered as a special client in advance and the other client devices 1, 2 cannot be registered as the other client devices 1, 2. Thus, the process servers 4˜6 can receive the login request from only the management server 3, and transfer information to and from the client device 1, 2 through the management server 3. Moreover, as the login request from the client devices 1, 2 is not received if it exists, the management server 3 can manage the process server 5.

Moreover in case of using the second mode as described above, both the management server 3 and the client devices 1 and 2 can be registered as client users, and they can login the process server 5. Consequently, the process server 5 can transfer information directly to and from the client devices 1 and 2, and if existing the management server 3, information can be transferred to and from the management server 3, same as the client devices 1 and 2.

The process unit 23 implements various processes, such as the print process is implemented if the process server 5 is a printer, scanner process is implemented if the process server 5 is a scanner, and the transmission process and the receipt process are implemented if the process server 5 is a facsimile device. Of course, the other process can also be implemented, or it can be constructed so as to implement various processes according to the request.

Additionally, the processes implemented in the process servers 4 and 6 are optional, and the process servers 4 and 6 can be a device which implements the same process as the process server 5 and it can be a device which implements the different process. Moreover, even in the case of the device which implements the same process, the processing power can be different.

Next, the operation in one example of the network system including the client device and the process server of the present invention will be described with reference to several examples. Additionally, the configurations of the client device and in the process server are not shown in the following drawings.

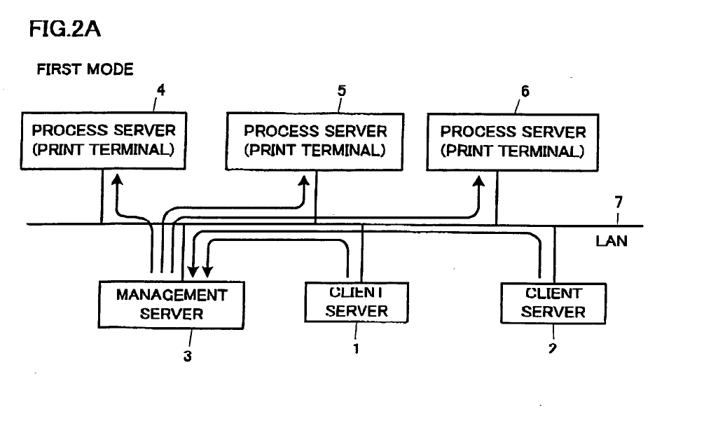

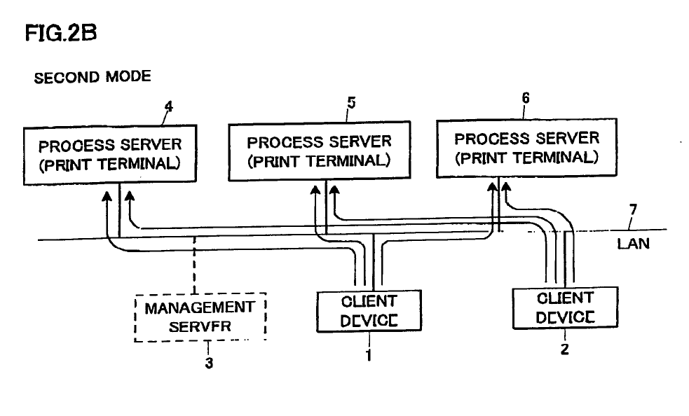

FIG. 2 shows the case that the process servers 4˜6 function as print terminals which implement the print process. First, FIG. 2A shows the case that information to be printed is transferred from the client devices 1, 2 to the process servers 4˜6 through the management server 3 in the first mode. In the case, even in the case of requesting the print to any one of the process servers 4˜6, the client devices 1, 2 can transmit information to be printed and information for printing to the management server 3. If using the first mode, even in case that the specifications of the process servers 4˜6 are different, the client devices 1, 2 have an advantage that the information to be printed can be transferred to the management server 3 uniformly. Moreover, users of the client devices 1, 2 can print without considering the characteristics of the respective process servers 4˜6, and further the software such as a printer driver is not needed to be prepared in the respective process servers 4˜6 of the client devices 1, 2.

In the management server 3, information transmitted from the client devices 1, 2 is transferred to any one of the process servers 4˜6 and is printed out. At the time, the management server 3 converts the information to print out according to the process server of the transferring destination, base on information related to printing process from the client devices 1, 2, and transfers to the process server. The process server of the transferring destination may be instructed from the client devices 1, 2, or can be parted in the management server 3 considering loads of the respective process servers 4 6 and a printing capability. Moreover, for example in printing in large quantities, the print volume can be parted to the process servers 4˜6 per certain pages or volumes and processed by working the process servers 4˜6 at the same time. As information of the print process is pooled as described above, various kinds of print management can be implemented. The process servers 4˜6 accept only login from the management server 3 and print out the information transmitted from the management server 3.

FIG. 2B shows the case that the information to be printed is transferred directly from the client devices 1, 2 to the process servers 4˜6 in the second mode. In the case, the respective client devices 1, 2 specify the process server to be printed out and transfer the information to be printed to the process server directly. In the second mode, it is translated into a data format in accordance with the process server to be printed out, and the information to be printed is transferred by the protocol in accordance with the process server. The process servers 4˜6 accept the login from the client devices 1, 2, and receive the information to be transferred, and print it out.

The second mode can also be corresponded to the system configuration that the management server 3 is not existed. Of course, as the management server 3 can also login as a client, the print out going through the management server 3 can be also used as the usage. Moreover, as information is transferred from the client devices directly to the respective process servers 4˜6, it is possible to print out using the abilities of the respective process servers 4˜6 to the full.

Additionally, though the process servers 4˜6 are described as the print terminals which implements the printout in the above description, the same applies to the process server which implements various process so as to request to process by transmitting information from the client devices 1, 2. For example, if the process servers 4˜6 are communication terminal devices having function of facsimile transmission process, information can be transmitted from the client devices 1 and 2 to the process servers 4˜6 through the management server 3 in the first mode, and information can be transmitted from the client devices 1, 2 directly to the process servers 4˜6. In the case, for example if transmitting information to a plurality of destinations such that information is transferred to the process servers 4˜6 through the management server 3 using the first mode and broadcasting, the management server 3 can transfer information to a plurality of the process servers and can also make them transmit the information at the same time.

In the above explanation with reference to FIG. 2, the case of transferring information to be printed out in the first mode or the second mode is described. Additionally in the present invention, the device setup information as well as the information to be printed out can be transferred to and from the respective process servers 4˜6 in the first mode or the second mode.

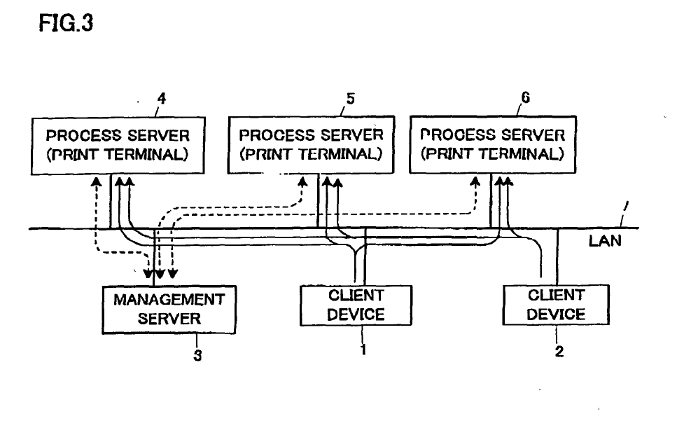

In an example shown in FIG. 3, a flow of the device setup information is shown in a broken line, and the device setup information is transferred in the first mode. In other words, after the device setup information is transferred from the client devices 1, 2 to the management server 3, the information is transferred from the management server 3 to the respective process servers 4˜6. Thus, as the device setup information is aggregated to the management server 3 when the device setup information is transferred though the management server 3 in the first mode, the management server 3 can easily manage the process servers 4˜6. Moreover, when the information to be printed out is transferred from the client devices 1, 2 directly to the process servers 4˜6 in the second mode, the management server 3 can only manage the process servers 4˜6 and the load of the management server 3 can be reduced.

Additionally, in the case that the device setup information is not transferred from the client devices 1, 2 and the management server 3 produces or transfers the device setup information to the respective process servers 4˜6, the process servers 4˜6 can transfer the device setup information in the first mode. The login request is not received from the client devices 1 and 2 other than the management server 3 in the first mode, so that the system is configured such that the device setup information is set only from the management server 3.

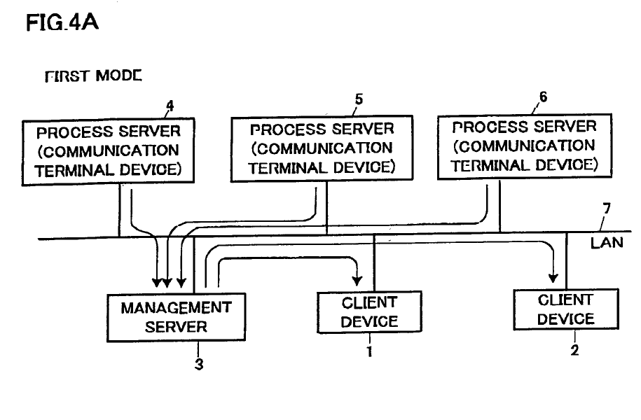

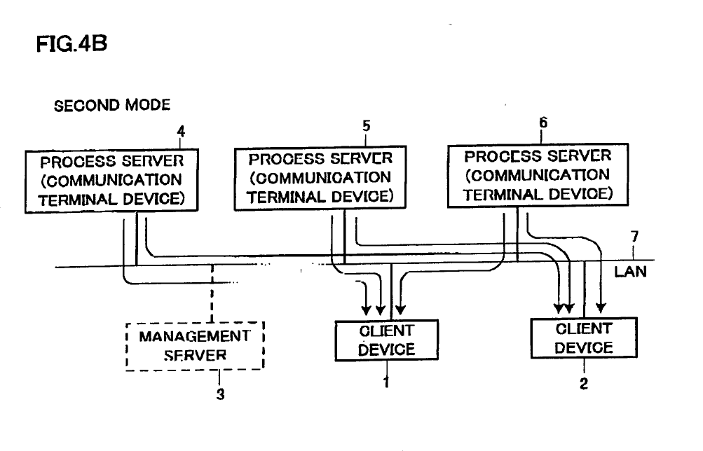

FIG. 4 shows the case that the process servers 4˜6 are the communication terminal devices having the facsimile receiving function. First, the case that information received by the process servers 4˜6 through the management server 3 in the first mode is delivered to the client devices 1, 2 is shown in FIG. 4A. In this case, the process servers 4˜6 also transmit information to the management server 3, that the information is delivered to any one of client devices 1, 2. Then, information of specifying a user or a client that receives the information is also transmitted to the management server 3. As the information delivered from the process servers 4˜6 to the client devices 1 and 2 is collected in the management server 3 in the first mode, the management server 3 can manage the delivering information all at once.

At the management server 3, the information transmitted from the process servers 4˜6 is transferred to the client device based on direction of the respective process servers 4˜6. At the time, if the client device of the transferring destination does not log in to the management server 3, the information is transferred after the login. If the data format and the communication protocol are different in every process server, the information can be translated in the management server 3 and the information can be transferred to the respective client devices 1, 2. Therefore, the information can be acquired from the management server 3 without reference to the specifications of the respective process servers 4˜6 in the respective client devices 1, 2. Moreover, the process servers 4˜6 do not need to translate the information in accordance with the respective client devices 1, 2.

Moreover, in case of information to a plurality of the client devices, the process servers 4˜6 can only transfer the information to the management server 3 once, and the management server 3 can deliver the information to each client device. Consequently, the load of the process servers 4˜6 can be reduced.

The case that the information received by the process servers 4˜6 in the second mode is transferred directly to the client devices 1, 2 is shown in FIG. 4B. In the case, the client device which becomes the transferring destination of the received information is specified based on the designated address when receiving information in the process servers 4˜6, and the received information is transferred directly to the specified client device.

The second mode can also correspond to a system configuration that the management server 3 is not existed. Of course, as the management server 3 can also log in as a client, the received information can also be delivered from the management server 3 to the client devices 1, 2 after transferring the received information to the management server 3 once.

In addition, though it is explained that the process servers 4˜6 are the communication terminal devices having the facsimile receiving function in the above, much the same is true on the process server which implements various processes so as to deliver information from the process servers 4˜6 to the client devices 1, 2. For example, if the process servers 4˜6 are network scanners having a scan process function of scanning an image on the document, in case of the first mode, scan input information is transmitted from the process servers 4˜6 to the client devices 1, 2 through the management server 3, and in case of the second mode, the information input and scanned by the process servers 4˜6 can be transmitted directly to the client devices 1, 2.

Moreover, in case of transferring information from the process servers 4˜6 to the client devices 1, 2 through the management server 3 or in case of transferring information directly to the client devices 1, 2, the device setup information can be transferred to and from the respective process servers 4˜6 in the first mode or the second mode as shown in FIG. 3.

The print process, the transmission process, the receiving process, and the scan process as described above are not confined to the process server with a single function, and a plurality of the processes can be implemented in one process server in a form of a multifunction peripheral. In the case, it can be constructed so as to set every process in the first mode or the second mode. For example, it is possible to use the first mode in the print process and the transmission process, and to use the second mode in the scan process and the receiving process.

Moreover, the information can also be transferred in the first mode or the second mode in the process server which processes information received from the client device (or the management server) and transfers the process result information to the client device (or the management server) as well as the process server which processes information received from the client device (or the management server) or the process server which transfers information to the client device (or the management server) as described above. In the case, it can be composed so as to set the first mode or the second mode in every transferring direction of the information such that the first mode is used from the client device to the process server and the second mode is used from the process server to the client device.

Of course, the various process servers as described above can also be existed on the LAN 7 with other devices, and a plurality of the management servers 3 can also be existed. In the case, it is possible to use the first mode or the second mode in accordance with the device, the process function, the device setup information, or the information to be processed, for example the first mode is used for a part of the process servers and the second mode is used for the other one part of the process servers.

What is claimed is:

1. A client device comprising:
a communication means for communicating with a process server or a management server through a Local Area Network (LAN); and
a control unit operating in a first mode transferring information to and from the process server through the management server by making the communication means communicate with the management server and operating in a second mode transferring information directly to and from the process server by making the communication means communicate with the process server.

2. The client device according to claim 1, wherein device setup information for the process server is transferred in the first mode and information to be processed in the process server is transferred in the second mode.

3. The client device according to claim 1, wherein information to be processed in the process server is transferred in the first mode and the device setup information for the process server is transferred in the second mode.

4. A process server comprising:
a communication means for communicating with a management server or a client device through a Local Area Network (LAN);
a process means for processing information; and
a control unit operating in a first mode where information transmitted from the client device is transferred to the process means, or the information processed by the process means is transmitted to the client device through the management server by making the communication means communicate with the management server and operating in a second mode where information received directly from the client device is transferred to the process means, or the information processed by the process means is transmitted directly to the client device by making the communication means communicate with the client device.

5. The process server according to claim 4, wherein device setup information for the process server is transferred in the first mode, and the information to be processed by the process means in the process server or the processed information is transferred in the second mode.

6. The process server according to claim 4, wherein the information to be processed by the process means in the process server or the processed information is transferred in the first mode and the device setup information for the process server is transferred in the second mode.

7. A network system comprising:
client device comprising a control unit operating in a first mode that information is transferred to and from a process server through a management server by making a communication means communicate with the management server and operating in a second mode that information is transferred directly to and from the process server by making the communication means communicate with the process server;
a process server comprising a communication means for communicating with the management server and the client device through LAN;
a process means for processing information;
a control unit operating in a first mode that information transmitted from the client device is transferred to the process means through the management server or information processed by the process means is transferred to the client device through the management server by making the communication means communicate with the management server and operating in a second mode that information received directly from the client device is transferred to the process means or information processed by the process means is transferred directly to the client device by making the communication means communicate with the client device.

8. The network system according to claim 7, wherein the client device communicates with the process server in the first mode to transfer the device setup information, and communicates in the second mode to transfer information to be processed in the process server.

9. The network system according to claim 7, wherein the client device communicates in the first mode to transfer the information to be processed in the process server, and communicates with the process server in the second mode to transfer the device setup information.

10. The network system according to claim 7, wherein the process server communicates in the first mode to transfer the device setup information regarding the process server, and communicates in the second mode to transfer the information to be processed by the process means in the process server or the processed information.

11. The network system according to claim 7, wherein the process server communicates in the first mode to transfer information to be processed by the process means in the process server or the processed information, and communicates in the second mode to transfer the device setup information regarding the process server.

12. A client device comprising:
a communication device for communicating with a process server or a management server through a Local Area Network (LAN); and
a control unit operating in a first mode transferring information to and from the process server through the management server by making the communication device communicate with the management server and operating in a second mode transferring information directly to and from the process server by making the communication device communicate with the process server.

13. The client device according to claim 12, wherein device setup information for the process server is transferred in the first mode and information to be processed in the process server is transferred in the second mode.

14. The client device according to claim 12, wherein information to be processed in the process server is transferred in the first mode and the device setup information for the process server is transferred in the second mode.

15. A process server comprising:
a communication device for communicating with a management server or a client device through a Local Area Network (LAN);
a processor for processing information; and
a control unit operating in a first mode where information transmitted from the client device is transferred to the processor, or the information processed by the processor is transmitted to the client device through the management server by making the communication device communicate with the management server and operating in a second mode where information received directly from the client device is transferred to the processor, or the information processed by the processor is transmitted directly to the client device by making the communication device communicate with the client device.

16. The process server according to claim 15, wherein device setup information for the process server is transferred in the first mode, and the information to be processed by the processor in the process server or the processed information is transferred in the second mode.

17. The process server according to claim 15, wherein the information to be processed by the processor or the processed information is transferred in the first mode and the device setup information for the process server is transferred in the second mode.

18. A method for communicating in a network comprising:
communicating with a process server or a management server through a Local Area Network (LAN);
operating in a first mode transferring information to and from the process server through the management server by communicating with the management server; and
operating in a second mode transferring information directly to and from the process server by communicating with the process server.

19. The method according to claim 18 further comprising transferring setup information for the process server in the first mode and transferring information to be processed in the process server in the second mode.

20. The method according to claim 18 further comprising transferring information to be processed in the process server in the first mode and transferring device setup information for the process server in the second mode.
